(19) United States
(12) Patent Application Publication
(10) Pub. No.: US 2026/0366928 A1
(43) Pub. Date: Nov. 19, 2026

(54) A SENSOR AND A SENSOR TAPE

(71) Applicant: Sathiyan PONNUSAMY, Rüsselsheim am Main (DE)

(72) Inventors: Sathiyan PONNUSAMY, Rüsselsheim am Main (DE); Immanuel Deepan MORAIS, Unterschleissheim (DE)

(21) Appl. No.: 19/477,399

(22) PCT Filed: Apr. 22, 2024
(86) PCT No.: PCT/EP2024/060976

§ 371 Date: Oct. 21, 2025

(30) Foreign Application Priority Data
Apr. 21, 2023 (DE) 10 2023 110 171.4

(51) Int. Cl. G01K 7/026; G01K 1/14; G01K 7/22

(52) U.S. Cl. CPC G01K 7/026; G01K 1/14; G01K 7/223

(57) ABSTRACT

A sensor having at least a first layer having a first set of signal paths, an electronic circuit configured to detect a first impact of signal paths based on signals read on signal paths and determine a location of said first impact based on signals read and further having at least a secondary sensing means for detecting a second impact thereof provided between at least two of the signal paths or on at least one of the signal paths. The electronic circuit is further configured to generate a status signal based on signals received from the signal paths where said secondary sensing means is connected.

### FIELD OF THE INVENTION

The invention relates to sensors comprising at least a first layer having a first set of signal paths; an electronic circuit is configured to detect damaged signal paths based on signals read on signal paths and determine a location of damage based on detected signal paths. Preferably, the invention relates to sensors comprising at least two or more different layer of signal paths, whereby an electronic circuit is configured to detect separately or simultaneously at least reads from the two different layers, and so to determine a location of a modality like damage and a further modality such as, e.g., temperature, pressure, fire, water or humidity based on the separately or simultaneously detected signal paths. Hence, particularly, the invention relates to one or more sensor means preferably embedded in a respective sensor tape and arranged in that allowing to detect one or more modalities such as damage, temperature, fire, water, pressure, liquid, humidity, vapour, gas, and mixtures thereof.

### BACKGROUND ART

Some products and devices require constant monitoring of physical and/or chemical factors affecting them. Such products and devices may be of high value such as satellites, military vehicles, liquid fuel storages, EV battery packs or airplanes, ships, cars or the like. Such products further may be clothing and prosthetic body parts that monitor body temperature, humidity and location of physical touch or impact.

Physical impact or damage and their location can be detected using security tapes having electrical wires thereon. Same applies to chemical impact or damage.

WO 2014/195756 A1 discloses a security tape comprising a mesh sensor strip in which a filament is woven or otherwise provided to serve as a single continuous signal path.

The filament may be an electrical wire or an optical fiber to carry, respectively, an electrical signal or an optical signal. The mesh sensor strip and bonded layers can be cut to any desired length, and each end of the filament is connectable to respective connector units. One connector unit is connected to a signal source, and the other connector unit is connected to a signal receiver. A break in the filament will cause a loss of constant continuous conduction and therefore loss of signal received by the receiver, thereby indicating an alarm condition. The security tape protects against both intrusion and extrusion events across any boundary of a volumetric space of the signal path and trigger an alarm indication.

U.S. Pat. No. 8,531,292 B2 discloses a panel that comprises a container device with a wall embedded with electrical fibers capable of detecting intrusions through the container walls. The electrical circuit extends across the said panel on the x-axis and y-axis in arrangements of the grids that extend to cover an entire panel. In the arrangement, an optical or electrical path is established through the grid, and the intrusion is detected when the fiber or wire is broken. The arrangement of the electrical paths along the horizontal and vertical lines is one of the grid patterns. Further, the optical or electrical path is established through the grid, such that the intrusion be detected when the fiber or wire is broken.

Other physical factors such as humidity, liquid exposure, temperature, pressure etc. are monitored using separate sensors placed near or inside containers of such products or devices. The present invention of the sensing means and/or sensor tapes disclosed herein is also enabled to detect one or more chemical damages such as acid spill or spill of hazardous fluid or the like.

### SUMMARY OF THE INVENTION

The present invention relates to a sensor and a sensor tape to bring new advantages to the relevant technical field.

An object of the invention is providing a sensor and a sensor tape capable of monitoring physical damage and at least one more other physical factor of products or devices that the sensor is attached to. Likewise, physical and/or chemical damages may be detected within the context of the present invention.

In one embodiment of the invention, additionally or alternatively the physical and/or chemical damage could also be caused by a corrosive chemical, corrosive liquid or corrosive vapour/gas. This can be sensed with the context of the present invention like a common physical damage.

Another object of the invention is to provide a sensor capable of monitoring physical damage, humidity, liquid exposure, temperature and pressure. But the present invention is not limited thereto and thus including chemical damages such as acid spill or spill of hazardous gas and/or fluid. Specifically, corrosive chemicals and gases may be detected with one or more sensing means and/or sensor tapes of the present invention. Such corrosive chemicals and gases may corrode electrical lines, e.g. of the sensing means and/or sensor tape, and thus disconnect said electrical lines yielding a signal of the signal path or the like.

Another object of the invention is to provide a sensor capable of monitoring location of physical factors.

Another object of the invention is to provide a sensor capable of monitoring location of chemical factors.

Another object of the invention is to provide a sensor capable of monitoring location of physical and chemical factors.

Another object of the invention is to provide a sensor and a sensor tape having increased physical flexibility.

Another object of the invention is to provide a sensor and a sensor tape having increased elasticity.

Another object of the invention is to provide a sensor and a sensor tape having a hardened configuration.

Another object of the invention is to provide a sensor and a sensor tape sensing a temperature.

Another object of the invention is to provide a sensor and a sensor tape sensing a pressure.

Another object of the invention is to provide a sensor and a sensor tape sensing a liquid.

Another object of the invention is to provide a sensor and a sensor tape sensing water.

Another object of the invention is to provide a sensor and a sensor tape sensing a gas, preferably a corrosive gas.

Another object of the invention is to provide a sensor and a sensor tape sensing a vapour, preferably a corrosive vapour.

Another object of the invention is to provide a sensor and a sensor tape sensing humidity.

Another object of the invention is to provide a sensor and a sensor tape sensing a mixture in any subcombination of the aforementioned modalities.

To achieve all the objects mentioned above and that will emerge from the following detailed description, the present invention relates to a sensor comprising at least a first layer having a first set of signal paths; an electronic circuit is configured to detect damaged signal paths based on signals read on signal paths and determine a location of damage based on signals read. Accordingly, it is characterized by comprising at least a secondary sensing means provided between at least two of the signal paths or on at least one of the signal paths; and said electronic circuit is further configured to generate a status signal based on signals received from signal paths where said secondary sensing means is connected. Thus, along with physical damage, other physical factors can be monitored at the same structure.

In another embodiment, the present invention relates to a sensor and/or a sensor tape comprising at least three layer having at least three independent sets of signal paths; an electronic circuit being configured to detect from said at least three signal paths three different modalities such as fire, humidity and acid spillage based on the signals read from the said signal paths and so to determine a location of fire, humidity and of acid spillage independently based on said signals read. Thus, along with physical impacts also chemical impacts or any other suitably detectable modality can be monitored at the same structure, but independently from another.

With the context of the invention a “modality”/“modalities” or similar terms denote a particular cause of damage, physical and/or chemical impact on the sensing means and/or sensor tapes of the invention, which exists or is experienced or expressed by/from a product having the said sensing means and/or sensor tape of the invention either partially or fully implemented.

A possible embodiment of the invention is characterized in that said secondary sensing means comprises a sub signal path provided between at least two of the signal paths or on one of the signal paths having a non-conducting section suitable for allowing signal transfer when exposed to a conducting fluid.

Another possible embodiment of the invention is characterized in that said non-conducting section is a gap.

Another possible embodiment of the invention is characterized in that said non-conducting section comprises a porous material suitable for at least partially absorbing said conducting fluid.

Another possible embodiment of the invention is characterized in that said porous material is a sponge.

Another possible embodiment of the invention is characterized in that said porous material is a fabric.

Another possible embodiment of the invention is characterized in that the electronic circuit is configured to apply current to one of the signal paths and measure current flow between at least two of the signal paths.

Another possible embodiment of the invention is characterized in that a plurality of sub signal paths are provided between at least two of the signal paths.

Another possible embodiment of the invention is characterized in that the electronic circuit is further configured to generate a signal indicating a level of liquid exposure based on detected current flow. Thus, the level of humidity or liquid exposure may be calculated.

Another possible embodiment of the invention is characterized in that wherein at least one of the signal paths comprises a first thermocouple section comprising a first metal and a second thermocouple section connected to said first thermocouple section, via a junction point, comprising a second metal where first metal is dissimilar to second metal; first thermocouple section and second thermocouple section are provided between a first end and a second end of signal path; and electronic circuit is configured to measure voltage between said first end of and said second end of the signal path and generate the status signal indicating temperature of said junction point.

Another possible embodiment of the invention is characterized in that wherein first thermocouple section is a first half of one of the signal paths and second thermocouple section is second half of said signal path.

Another possible embodiment of the invention is characterized in that wherein metals are selected from a group of metals that are used for forming a B, E, J, K, N, R, S or T type thermocouples. The said group of metals is a group consisting of noble metals, alkali metals, alkaline earth metals, transition metals, and metalloids.

Another possible embodiment of the invention is characterized in that wherein secondary sensing means is a thermistor provided between at least two of the signal paths electrically connecting the first signal path the second signal path or provided on a signal path.

Another possible embodiment of the invention is characterized in that wherein electronic circuit is configured to apply current to one end of the thermistor and measure current at the other end of the thermistor and generate a status signal indicating temperature of said thermistor.

Another possible embodiment of the invention is characterized in that wherein said thermistor is in the form of a plate.

Another possible embodiment of the invention is characterized in that comprising a third layer having a first electrode and a second electrode; a pressure sensitive conductive sheet provided between said first electrode and said second electrode; the electronic circuit is configured to apply current to first electrode or second electrode and measure current flow between first electrode and second electrode; and generate a status signal based on measured current indicating pressure applied to pressure sensitive conductive sheet. Thus, pressure applied to product or devices can be detected. This also allows detecting if an entity that sensor is attached to is bent.

Another possible embodiment of the invention is characterized in that wherein at least a second layer having a second set of signal paths, where first set of signal paths and second set of signal paths extend along different axis so that they form a mesh like form when first layer and second layer applied on top of each other.

Another possible embodiment of the invention is characterized in that wherein signal paths are arranged at least two of the x, y, z axis.

The invention is also a sensor tape having one of the above-mentioned sensor embodiments.

Another possible embodiment of the invention is characterized in that wherein it comprises an adhesive layer.

The invention is also a sensor plate having one of the above-mentioned sensor embodiments.

The invention is also a packaging comprising one of the above-mentioned sensor embodiments.

The invention is also a product having one of the above-mentioned sensor embodiments.

The invention is also a product having one of the herein mentioned sensor and/or sensor tape embodiments.

Additionally or alternatively, the thermocouple and/or thermistor and/or the pressure sensing unit of the present invention may also be used to detect a physical damage, assuming when no electrical signal at all is passed from the first end to the second end. Even one or both part of their signal path may also be the meandered pattern of the invention in order to detect a physical damage additionally.

Additionally or alternatively, the thermistor of the invention may also be a blob or bulge, either small or large in suitable size, so that it does not affect any other sensor functionality or its application of the sensor tape, plate or product housing.

In accordance with the present invention, the sensor tape and/or the sensing means not necessarily have to have a smooth surface. Rather, in an embodiment the sensor tape and/or the sensing means of the invention can have irregular surfaces; e.g. being bulged in case of a plurality of thermistors in the form of a bulge or a blob, but not being limited thereto. Likewise, the irregular surface having some form of extrusions on the surface may create a non-smoothen surface of a particular shape. Thereby, transition of the shape may be fluent; e.g. from softly bulged towards densely bulged or vice versa or mixtures thereof scattered across the surface of the sensor tape and/or the sensing means. Following this, having a smooth surface is one option of the invention for the sensor tape and/or the sensing means, but not an essential feature thereof.

Hence, the provided irregularities on the surface of the sensor tape and/or the sensing means do not necessarily have to be provided in a uniform manner. Rather, it may well be that smaller and bigger thermistor bulges or the like may be present scattered non-uniformly across the surface as sensing means.

Rather the functionality of the combination of at least two different sensing means is preferred with the context of the invention, and not providing a uniform surface on the sensor tape and/or sensing means.

Accordingly, the sensor tape and/or sensing means of the invention may be provided in various forms and shapes and are not limited as such. For instance, the sensor tape may be provided as an elastic bond or elastic tape which can be manufactured in desired length, pieces and shapes on 2D and/or 3D level.

Additionally or alternatively, the sensor tape and/or the sensing means of the invention may have a functional surface such as an extruded surface with forming one or more cavities that may serve as a reservoir for absorbance of ambient water; e.g. from ambient air condensed on the surface of the sensor tape and/or the sensing means.

Additionally or alternatively, the sensor tape and/or the sensing means of the invention may have a functional surface such as an extruded surface with forming one or more shapes that may serve as a reservoir for furthering evaporation of ambient water on the surface of the sensor tape and/or the sensing means.

Generally with the context of the invention at least one sensing means in a sensor tape is necessary to sense one modality like damage, pressure, temperature, liquid, vapour, gas, fire, humidity etc. However, with the context of the invention the sensing/detection of at least two or more modalities such as damage, pressure, temperature, liquid, fire, vapour, gas, humidity etc. is preferred. With the context of the invention also the first modality detected by the sensing means and/or sensor tape of the invention must not necessarily be a physical damage. Also a chemical damage or humidity may be a first modality to be detected that may be combined by any other of the modalities conceivable with the context of the invention for the skilled artisan.

Moreover, the present inventors foresee multiple ways on how to implement the sensors and/or sensor tapes of the invention. For instance, the sensors and/or sensor tapes may be fully or partially embedded in a product, e.g. in a housing of a product, such as being fully embedded in a fuel tank of an airplane. Thereby, the sensors and/or sensor tapes may be fully or partially elastic. Additionally or alternatively, the sensors and/or sensor tapes may be fully or partially hardened. Additionally or alternatively, the sensors and/or sensor tapes may be provided fully or partially in a plate manner. Within the concept of the present invention, also mixtures of all the foregoing of this paragraph may be provided. Hence, the present invention also provides for any suitable subcombination of all the foregoing disclosure. For instance, there may be a subcombination of a fire and water detection within the same sensor tape. Thereby, the areas for fire and water detection may be separated or admixed, and may differ in size and configuration. However, the respective sensing means are arranged in a way that failure of detection of one of these modalities (e.g. for fire or water) does not affect the other modality detection. Meaning that if fire detection has a malfunction, the water detection remains feasible due to construction and arrangement of the separate sensing means within the same sensor tape. For instance, the sensing means for different modalities may be arranged in a way that replacement of one non-functioning detection modality is well replaceable by new spare parts for working sensing means. Transferred this to an exemplary case, the liquid sensing means in a sensor tape for a fuel tank of an airplane though having a malfunction, would not affect the respective fire sensing means still intact in the very same sensor tape. This is realized by the arrangement and configuration as disclosed herein of the separate sensing means in the sensor tape, for instance, when being embedded in a fuel tank of an airplane.

### BRIEF DESCRIPTION OF THE DRAWINGS

FIG. 1 is a drawing illustrating a schematic view of the sensor.

FIG. 2 is a drawing illustrating a schematic view of another embodiment of the sensor.

FIG. 3 is a drawing illustrating signal paths having meandered sections.

FIG. 4 is a drawing illustrating an embodiment of humidity/liquid sensing means.

FIG. 5 is a drawing illustrating another embodiment of humidity/liquid sensing means.

FIG. 6 is a drawing illustrating pressure sensing means.

FIG. 7 is a drawing illustrating an embodiment of sensor having meandered sections, humidity/liquid sensing means, pressure sensing means and temperature sensing means. Additionally, FIG. 7 illustrates a damage detection area (see (201)).

FIG. 8 is a drawing illustrating the sensor tape.

FIG. 9 is a drawing illustrating the sensor plate.

### DETAILED DESCRIPTION OF THE PREFERRED EMBODIMENT

In this detailed description, the subject matter is explained with references to examples without forming any restrictive effect, only in order to make the subject more understandable.

The present invention is a sensor (10) that is suitable for detecting damage, location of damage and a secondary physical property such as humidity, liquid exposure, pressure or temperature. Likewise, the first or second property can be a chemical impact such as spillage of an acid or the like.

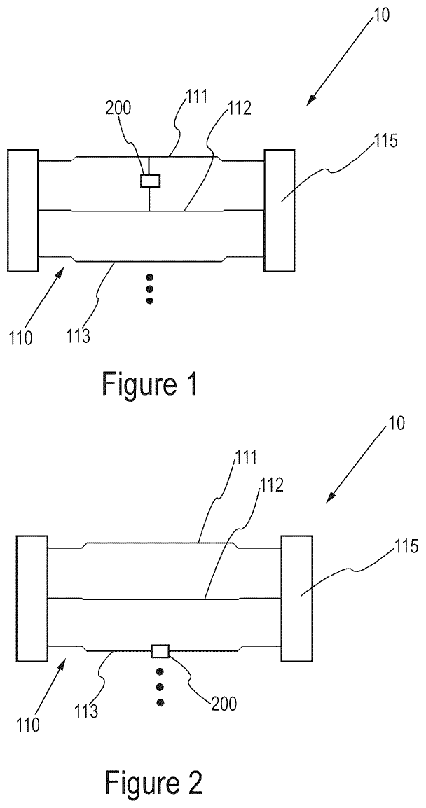

Referring to FIG. 1, sensor (10) comprises a first layer and plurality of signal paths (110) connected in parallel, provided in said first layer. An electronic circuit (115) is connected to the signal paths (110). Electronic circuit (115) is configured to read signals on signal paths (110). Electronic circuit (115) is configured to generate a signal when a signal path (110) is broken, indicating a damage and a location of the damage. The sensor further comprises a secondary sensing means (200) connected between at least a first signal path (111) and a second signal path (112). Referring to FIG. 2 in a possible embodiment secondary sensing means (200) is provided on a third signal path (113). Electronic circuit (115) is configured to generate a status signal indicating secondary physical property.

In a possible embodiment, electronic circuit (115) may be configured to apply current to signal paths (110) from one end and read said current from the other end of the signal path (110). When a signal path (110) is broken, electronic circuit (115) will detect damage when no current is read on damaged signal path (110).

Electronic circuit (115) may comprise components for measuring current, applying current, calculating values depending on measured signals or sent signals. Electronic circuit (115) may comprise integrated circuits and other well-known components in order to provide the functionality needed by the invention.

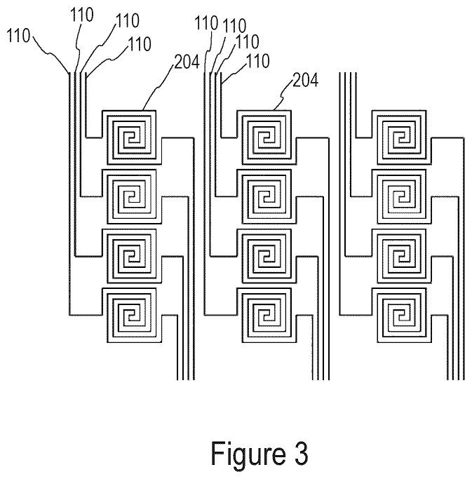

Referring to FIG. 3, in a possible embodiment, signal paths (110) comprise meandered sections (204) where signal path (110) is meandered for covering more area. Said meandered sections (204) are provided as thin wires can be broken when exposed to an impact. When neighboring meandered sections (204) of parallel signal paths (110) are broken, location of damage can be detected more precisely.

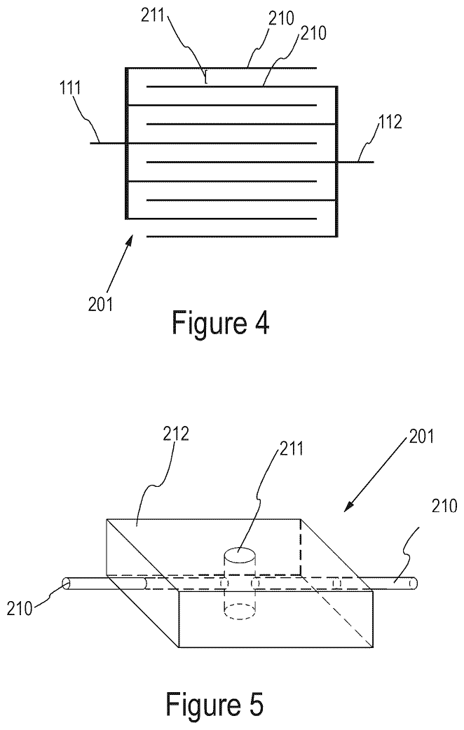

Referring to FIG. 4, secondary sensing means (200) may be a humidity/liquid sensing means (201). In a possible embodiment a plurality of sub signal paths (210) is provided between at least a first signal path (111) and a second signal path (112). Said sub signal paths (210) comprise a non-conducting section (211). Electronic circuit (115) is configured to apply current to one end of the sub signal path (210) and measure current flow on the other end of sub signal path (210). Electronic circuit (115) is configured to generate a status signal depending on the measured current. When a conductive liquid such as water fills the non-conduction section and connects ends of sub signal path (210). This allows current to pass through, and electronic circuit (115) generates a status signal indicating liquid exposure.

In a possible embodiment, said non-conducting section (211) is a gap. Referring to FIG. 4, a plurality of sub signal paths (210) is provided stretching out from one signal path (110) to other signal path (110) without touching other signal paths (110) or other sub signal paths (110) (210) in a comb like manner. Therefore, a plurality of gaps is provided between sub signal paths (210).

Referring to FIG. 5, secondary sensing means (200) may be a humidity/liquid sensing means (201). In this embodiment non-conducting section (211) is a gap and a porous material (212) is provided encapsulating said non-conducting section (211). Said porous materials (212) is suitable for absorbing liquid when exposed to. When moisture or liquid gathered in vicinity of non-conducting section (211), porous material (212) absorbs it. When porous material (212) absorbs liquid, non-conducting material is filled and provides connection in order to allow current to flow.

In a possible embodiment porous material (212) is a sponge. In another possible embodiment said porous material (212) is a fabric.

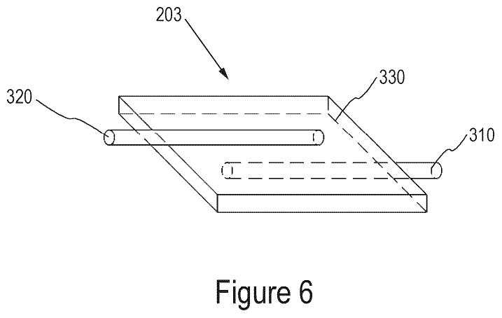

Referring to FIG. 6, in a possible embodiment secondary sensing means (200) may be a pressure sensing means (203). Further, secondary sensing means (200) comprises a first electrode (310) and a second electrode; (320) a pressure sensitive conductive sheet (330) is provided between said first electrode (310) and said second electrode (320). Electronic circuit (115) is configured to apply current to one of the electrodes and measure the current flow from the other electrode. Since pressure sensitive conductive sheet's (330) resistance is altered based on pressure applied thereon, current passing through pressure sensitive conductive alters accordingly. Therefore, pressure estimation may be realized by electronic circuit (115). Pressure sensing means (203) may be provided on a signal path (110) or between two signal paths (110). In a possible embodiment pressure sensing means (203) may be provided as another layer for placing on top of each other with first layer.

In that comprising a third layer having a first electrode (310) and a second electrode (320); a pressure sensitive conductive sheet (330) provided between said first electrode (310) and said second electrode; (320) electronic circuit (115) is configured to apply current to first electrode (310) or second electrode (320) and measure current flow between first electrode (310) and second electrode; (320) and generate a status signal based on measured current indicating pressure applied to pressure sensitive conductive sheet (330). In a possible embodiment secondary sensing means (200) may be a temperature sensing means (202). In a possible embodiment secondary sensing means (200) is a thermistor provided between two signal paths (110) or on a signal path (110). The control circuit is configured to apply current to one end of the thermistor and measure current at the other end of the thermistor. Therefore, the control circuit may be configured to generate a status signal indicating temperature.

In another possible embodiment, temperature sensing means (202) may be a thermocouple (not shown in the figures). At least one of the signal paths (110) may comprise a first thermocouple section comprising a first metal and a second thermocouple section connected to first thermocouple section via a junction point comprising a second metal wherein first metal is dissimilar to second metal. First thermocouple section and second thermocouple are provided on a signal path (110) between a first end and a second end. The control unit is configured to measure voltage between said first end and a second end and generate a status signal indicating temperature.

Metals are dissimilar in a manner that they can cause a Seebeck Effect. First metal and second metal are selected from the group of metals that are used for forming A, B, E, J, K, N, R, S or T type thermocouples.

In one embodiment first half of a signal path (110) is first thermocouple section (220) and second half of a signal path (110) is second thermocouple section (230).

In a possible embodiment sensor (10) may comprise more than one type of secondary sensing means (200) at the same time. In a possible embodiment, sensor (10) device may comprise at least two of humidity/liquid sensing means; (201) temperature sensing means; (202) pressure sensing means (203) as secondary sensing means (200).

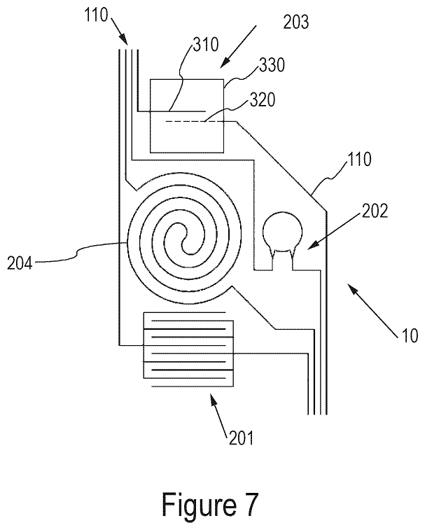

Referring to the exemplary embodiment of FIG. 7, sensor (10) may comprise (204) meandered sections, humidity/liquid sensing means (201), pressure sensing means (203) and temperature sensing means (202). This structure may be defined as a sensing unit.

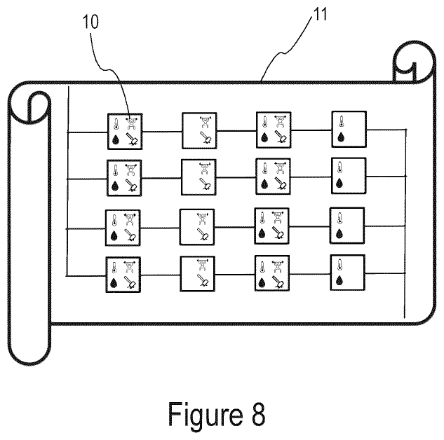

Referring to FIG. 8, sensor (10) may comprise plurality of sensing units connected in parallel and in series. The sensor may be provided as a sheet, defined as a sensor sheet (11). The sensor may comprise an adhesive layer for allowing the sensor to be attached to objects.

There may be appropriate combinations of sensing units connected in parallel and in series. Sensing units may comprise varying type and number of secondary sensing means (200). For instance, a sensor having 4 rows and 4 columns of signal paths (110) may comprise 9 pressure detection means with 3*3 arrangements, 9 humidity/liquid sensing means (201) in 3*3 arrangements, 9 temperature sensing means (202) with 3*3 arrangements. All the signal paths (110) may be used to function for damage location detection.

Following the above, additionally or alternatively there may be appropriate combinations of sensing units/sensing means of the invention connected in parallel and in series with 2*4; 3*1; 4*4 arrangements or the like—thus not being limited thereto.

Moreover, the present invention foresees the application of the sensor tape of the invention in an irregular shape and/or order and/or arrangement, and combinations thereof. For instance, the sensor tape may be cut out or manufactured in such a way that it is applicable to a ball or a cone with a hemisphere. The present invention is explicitly not restricted towards a particular shape, order, or arrangement of sensor means, signaling paths and sensor tapes.

Alternatively or additionally, the sensor tape may comprises a connecting means suitable for connecting the sensor tape with, e.g., a sensor plate of the invention or whatsoever other entity or product.

Alternatively or additionally, the sensing means and/or sensor tape of the invention may also make use of a printable conductive ink; e.g. additionally to or instead of metal wires, to transfer the electrical/conductive signals. Such an embodiment with a printable conductive ink may increase the elasticity of the sensor tape of the invention for respective technical applications. For instance, a very elastic sensor tape my be needed for application thereof on irregular-shaped products such as a ball or the like.

Alternatively or additionally, the sensor tape of the invention may also be made from or having an elastic and/or stretchable material in all the said x, y, z axes; preferably with an elastic conductive path such as via the said printable conductive ink.

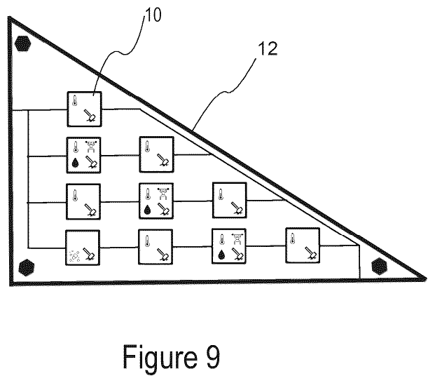

Referring to FIG. 9, the sensor may be provided in a sensor plate (12) form. This structure can be mounted or attached to products, packaging etc. Thus, damage status and secondary physical properties of said objects can be tracked. In a possible embodiment, a sensor may be embedded into products.

The sensor may be provided in appropriate shapes according to the objects that it will be attached or embedded to.

In a possible embodiment, at least a second layer having a second set of signal paths (110) where first set of signal paths (110) and second set of signal paths (110) extend along different axis so that they form a mesh like form when first layer and second layer applied on top of each other. Thus, when a status signal is generated from one signal path (110) from each layer, their intersection may be utilized in order to locate the cause of the status signal. For instance, when a first signal path (111) is detected to be broken on first layer, and a second signal path (112) is detected to be broken on second layer. The intersection of said signal paths (110) would be the location of impact point of damage.

In another embodiment, set of signal paths (110) in different layers may be arranged at least two of x, y and z axis. In a possible embodiment, 3 set of 3 signal paths (110) provided in 3 different layers may be arranged in x, y and z axis.

The connected electric circuit may have a sensor calibration method based on the actual values and sensed values. This may be done once after the sensors are mounted on the object and before the application started. This may also be done in a periodic manner in between application to ensure the continuous accuracy of the sensor. The calibration method may also utilize a controlled test environment where predetermined temperature, humid and pressure values are simulated and the sensor or the electronic circuit (115) is adjusted to output a more accurate value. Sensor calibration for different types of sensors or different rows or columns shall be done separately.

Sensor, sensor tape (11) or sensor plate (12) may be utilized in following areas: Shipping boxes of high value goods embedded with damage detection sensor to prevent mishandling. Sensor plates (12) with humid, temperature and damage detection sensors mounted on liquid fuel storage facility tanks with a monitoring system for leaks, fire or tank damage. Satellites manufactured with the sensor embedded in the outer body and the solar panels to detect physical damage and temperature variations. Combat or military vehicles such as fighter jets and battleships with the outer body embedded with a damage, temperature and humid detection sensors can directly identify a physical damage, possible fire or fuel leak with an exact location of the body without physical/ visual inspection even during the active operation. EV battery packs with stickable sensor tape (11) applied on the outer surface to monitor temperature irregularities, pressure caused due to bulge of the batteries and presence of water. Prosthetic body parts embedded with damage, temperature, humid and pressure sensors to simulate an artificial skin. Especially the palm of a prosthetic hand to feel grip strength, gripping object's temperature and liquid presence on it. Sensor embedded in fabrics of sports clothes for high performing athletes to monitor the body temperature, sweating rate and physical pressure on certain body parts. Shipping containers with all the sensors to detect break open situation and alarm application. Inside Bank locker walls with damage and temperature detection to alert any robbery situation. Sports vehicles with embedded sensors on the body parts to detect damages on the spoilers or aerodynamic parts while the vehicle is still running on the track etc.

In a further aspect of the invention, the herein disclosed sensing means may be combined in any suitable combination even without the first sensing means relating a damage detection. That is, for instance, two different sensing means of the invention may be combined for temperature and humidity detection or liquid and pressure detection or the like.

Also disclosed herein per the invention is a conductive liquid sensing means, but without any liquid absorbing materials. This is exemplified in FIG. 4. The respective fork-like conductive structures are directly placed on the surface of the sensor tape/plate. When there is an exposure to a conductive fluid, and at least one of the wires are connected, this sensing means can identify the fluid presence. FIG. 7 also reflects this sensing method.

The scope of protection of the invention is specified in the attached claims and cannot be limited to those explained for sampling purposes in this detailed description. It is evident that a person skilled in the art may exhibit similar embodiments in light of the above-mentioned facts without drifting apart from the main theme of the invention.

### REFERENCE NUMBERS GIVEN IN THE FIGURES

10 sensor
11 sensor tape
12 sensor plate
110 signal paths
111 first signal path
112 second signal path
113 third signal path
115 electronic circuit
200 secondary sensing means
201 humidity/liquid sensing means
202 temperature sensing means
203 pressure sensing means
204 meandered sections
210 sub signal path
211 non-conducting section
212 porous material
310 first electrode
320 second electrode
330 pressure sensitive conductive sheet

In view of all the foregoing disclosure, the present invention further comprises the following consecutively numbered embodiments:
1. A sensor (10) comprising at least a first layer having a first set of signal paths; (110) an electronic circuit (115) is configured to detect damaged signal paths (110) based on signals read on signal paths (110) and determine a location of damage based on signals read and further comprising at least a secondary sensing means (200) provided between at least two of the signal paths (110) or on at least one of the signal paths; (110) and said electronic circuit (115) is further configured to generate a status signal based on signals received from signal paths (110) where said secondary sensing means (200) is connected.
2. The sensor (10) according to embodiment 1, wherein said secondary sensing means (200) comprises a sub signal path (110) (210) provided between at least two of the signal paths (110) or on one of the signal paths (110) having a non-conducting section (211) suitable for allowing signal transfer when exposed to a conducting fluid.
3. The sensor (10) according to embodiment 2, wherein said non-conducting section (211) is a gap.
4. The sensor (10) according to embodiment 2, wherein said non-conducting section (211) comprises a porous material (212) suitable for at least partially absorbing said conducting fluid.
5. The sensor (10) according to embodiment 4, wherein said porous material (212) is a sponge.
6. The sensor (10) according to embodiment 4, wherein said porous material (212) is a fabric.
7. The sensor (10) according to embodiment 2, wherein the electronic circuit (115) is configured to apply current to one of the signal paths (110) and measure current flow between at least two of the signal paths (110).
8. The sensor (10) according to embodiment 7, wherein plurality of sub signal paths (110) (210) provided between at least two of the signal paths (110).
9. The sensor (10) according to embodiment 8, wherein the electronic circuit (115) is further configured to generate a signal indicating a level of liquid exposure based on detected current flow.
10. The sensor (10) according to embodiment 1, wherein at least one of the signal (110) paths comprises a first thermocouple section comprising a first metal and a second thermocouple section connected to said first thermocouple section, via a junction point, comprising a second metal where first metal is dissimilar to second metal; first thermocouple section and second thermocouple section are provided between a first end and a second end of signal path; (110) and electronic circuit (115) is configured to measure voltage between said first end of and said second end of the signal path (110) and generate the status signal indicating temperature of said junction point.
11. The sensor (10) according to embodiment 10, wherein first thermocouple section is a first half of one of the signal paths (110) and second thermocouple section is second half of said signal path (110).
12. The sensor (10) according to embodiment 10, wherein metals are selected from group of metals that are used for forming a B, E, J, K, N, R, S or T type thermocouples.
13. The sensor (10) according to embodiment 1, wherein secondary sensing means (200) is a thermistor provided between at least two of the signal paths (110) electrically connecting the first signal path (111) the second signal path (112) or provided on a signal path (110).
14. The sensor (10) according to embodiment 13, wherein electronic circuit (115) is configured to apply current to one end of the thermistor and measure current at the other end of the thermistor and generate a status signal indicating temperature of said thermistor.
15. The sensor (10) according to embodiment 13, wherein said thermistor is in form of a plate.
16. The sensor (10) according to embodiment 1 and further comprising a third layer having a first electrode (310) and a second electrode; (320) a pressure sensitive conductive sheet (330) provided between said first electrode (310) and said second electrode; (320) electronic circuit (115) is configured to apply current to first electrode (310) or second electrode (320) and measure current flow between first electrode (310) and second electrode; (320) and generate a status signal based on measured current indicating pressure applied to pressure sensitive conductive sheet (330).
17. The sensor (10) according to embodiment 1, wherein at least a second layer having a second set of signal paths (110) where first set of signal paths (110) and second set of signal paths (110) extend along different axis so that they form a mesh like form when first layer and second layer applied on top of each other.
18. The sensor (10) according to embodiment 1, wherein signal paths (110) are arranged at least two of the x, y, z axis.
19. A sensor tape (11) comprising a sensor according to one of the embodiments 1-18.
20. The sensor tape (11) according to embodiment 19, wherein it comprises an adhesive layer.
21. A sensor plate (12) comprising a sensor according to one of the embodiments 1-18.
22. The sensor plate (12) according to embodiment 21, and further comprising connection elements suitable for connecting to a product.
23. A packaging comprising a sensor according to one of the embodiments 1-18.
24. A product comprising a sensor according to one of the embodiments 1-18 wherein said sensor is embedded to said product.

1. A sensor comprising at least a first layer having a first set of signal paths, an electronic circuit is configured to detect at least a first impact of the signal paths based on signals read on signal paths and determine a location of said first impact based on signals read and further comprising at least a secondary sensing means for detecting at least a second impact of the signal paths other than the said first impact and being provided between at least two of the signal paths or on at least one of the signal paths, and said electronic circuit is further configured to generate a status signal based on signals received from signal paths where said secondary sensing means is connected, and
wherein said secondary sensing means comprises a sub signal path provided between at least two of the signal paths or on one of the signal paths having a non-conducting section suitable for allowing signal transfer when exposed to said second impact.

2. The sensor according to claim 1, wherein independently from one another the first and second impact of the signal paths is selected from the group consisting of a physical damage, a chemical damage, a fire, a liquid, a pressure, a vapour, humidity, a temperature, and a gas.

3. The sensor according to claim 1, wherein said non-conducting section is a gap.

4. The sensor according to claim 1, wherein said non-conducting section comprises a porous material suitable for at least partially absorbing said conducting fluid.

5. The sensor according to claim 4, wherein said porous material is a sponge.

6. The sensor according to claim 4, wherein said porous material is a fabric.

7. The sensor according to claim 1, wherein the electronic circuit is configured to apply current to one of the signal paths and measure current flow between at least two of the said signal paths.

8. The sensor according to claim 1, wherein a plurality of sub signal paths is provided between at least two of the signal paths.

9. The sensor according to claim 1, wherein the electronic circuit is further configured to generate a signal indicating a level of the said at least first and/or at least second impact exposure based on detected current flow.

10. The sensor according to claim 1, wherein at least one of the signal paths comprises a first thermocouple section comprising a first metal and a second thermocouple section connected to said first thermocouple section, via a junction point, comprising a second metal where first metal is dissimilar to second metal; first thermocouple section and second thermocouple section are provided between a first end and a second end of signal path, and electronic circuit is configured to measure voltage between said first end of and said second end of the signal path and generate the status signal indicating temperature of said junction point.

11. The sensor according to claim 10, wherein the first thermocouple section is a first half of one of the signal paths and the second thermocouple section is a second half of said signal path.

12. The sensor according to claim 11, wherein the metal is selected from a group of metals that are used for forming a B, E, J, K, N, R, S or T type thermocouples.

13. The sensor according to claim 1, wherein the secondary sensing means is a thermistor provided between at least two of the signal paths electrically connecting the first signal path and the second signal path or provided on a signal path.

14. The sensor according to claim 13, wherein the electronic circuit is configured to apply current to one end of the thermistor and measure current at the other end of the thermistor and generate a status signal indicating temperature of said thermistor.

15. The sensor according to claim 13, wherein said thermistor is in form selected from the group consisting of a plate, a bulge, a blob or mixtures thereof or any suitable form of an extruded structure.

16. The sensor according to claim 1 and further comprising a third layer having a first electrode and a second electrode, a pressure sensitive conductive sheet provided between said first electrode and said second electrode, the electronic circuit is configured to apply current to said first electrode or second electrode and measure current flow between said first electrode and second electrode, and generate a status signal based on measured current indicating pressure applied to pressure sensitive conductive sheet.

17. The sensor according claim 1, wherein at least a second layer having a second set of signal paths where first set of signal paths and second set of signal paths extend along different axis so that they form a mesh like form when first layer and second layer applied on top of each other.

18. The sensor according to claim 1, wherein the signal paths are arranged at least two of the x, y, z axis.

19. The sensor according to claim 1, additionally or alternatively comprising a, preferably printable, conductive ink, particularly additionally to or instead of the said metal wires, to transfer the electrical/conductive signals.

20. A sensor tape comprising a sensor according to claim 1.

21. The sensor tape according to claim 20, wherein it comprises an adhesive layer.

22. The sensor tape according to claim 20 being manufactured from or having an elastic and/or stretchable material in all x, y, z axes, preferably further comprising an elastic conductive path such as via the said, preferably printable, conductive ink as defined in claim 19.

23. The sensor tape according to claim 20 and further comprising one or more connection elements suitable for connecting the said sensor tape to a product, preferably the housing of a product.

24. A sensor plate comprising a sensor according to claim 1.

25. The sensor plate according to claim 24, further comprising one or more connection elements suitable for connecting the said sensor plat to a product, preferably the housing of a product.

26. A packaging comprising a sensor according to claim 1.

27. A product comprising a sensor according to claim 1, wherein said sensor is at least partially or fully embedded in/to said product.

28. The sensor according to claim 1 having at least one of: a) a substantially smooth surface; b) a substantially irregular surface; c) a bulged surface; d) an elastic configuration; and e) a hardened configuration.

29. The sensor tape according to claim 20 having at least one of: a) a substantially irregular surface; b) a substantially smooth surface; c) a substantially bulged surface; d) an elastic configuration; and e) a hardened configuration.

30. The sensor plate according to claim 24 having at least one of: a) a substantially bulged surface; b) a smooth surface; c) a substantially irregular surface; d) an elastic configuration; and e) a hardened configuration.

31. (canceled)

32. (canceled)
